(19) United States
(12) Patent Application Publication
(10) Pub. No.: US 2009/0278952 A1
(43) Pub. Date: Nov. 12, 2009

(54) VIDEO PROCESSING METHOD AND VIDEO PROCESSING SYSTEM

(76) Inventors: Ying-Jieh Huang, Taipei County (TW); Rui-Rui Lai, Guangzhou (CN)

Correspondence Address: NORTH AMERICA INTELLECTUAL PROPERTY CORPORATION, P.O. BOX 506, MERRIFIELD, VA, 22116, US

(21) Appl. No.: 12/179,588

(22) Filed: Jul. 25, 2008

(30) Foreign Application Priority Data
May 6, 2008 (TW) 097116599

(51) Int. Cl. H04N 5/228; H04N 5/04

(52) U.S. Cl. 348/222.1; 348/500; 348/E05.009; 348/E05.031

(57) ABSTRACT

A video processing method includes: storing a video data corresponding to a specific view angle range; selecting a plurality of target objects in the video data corresponding to the specific view angle range; generating a synthesized video data by combining each partial video data in the video data that corresponds to each of the target objects; wherein a view angle range of each partial video data is smaller than the specific view angle range.

### BACKGROUND OF THE INVENTION

1. Field of the Invention

The present invention relates to video processing, and more particularly to a video processing method that captures a plurality of partial video data corresponding to smaller view angle ranges from video data corresponding to a larger view angle range to generate a synthesized video, and a video processing system thereof.

2. Description of the Prior Art

Net meeting systems are extensively applied in most companies and in remote teaching systems. By using the net meeting system, a meeting can be held in realtime even if the attendees are on opposite sides of the world. In order to create as interactive an experience as possible, each attendee may hope to clearly see the facial expression of every other attendee. The view angle limitation of the conventional video capturing device (such as a network camera), however, limits the conventional video capturing device to only capturing one scene or attendee at a time. In order to clearly see the facial expression of each attendee, the conventional way is to provide a network camera for each attendee. This not only increases the cost of the net meeting system, but further wastes network resources since the transmission of the video data requires a large network bandwidth. Therefore, a more effective way of capturing a plurality of video data for net meetings is a current consideration in the field.

### SUMMARY OF THE INVENTION

Therefore, one of the objectives of the present invention is to provide a video processing method that captures a plurality of partial video data corresponding to smaller view angle ranges from a video data corresponding to larger view angle range to generate a synthesized video, and to provide a video processing system thereof to solve the above-mentioned problem.

According to an embodiment of the present invention, a video processing method is disclosed. The video processing method comprises the steps of: storing a video data corresponding to a specific view angle range; selecting a plurality of target objects in the video data corresponding to the specific view angle range; and generating a synthesized video data by combining each partial video data in the video data that corresponds to each of the target objects; wherein a view angle range of each partial video data is smaller than the specific view angle range.

According to an embodiment of the present invention, a video processing system is disclosed. The video processing system comprises a storage device, and a processing module. The storage device is used for storing a video data corresponding to a specific view angle range; and the processing module coupled to the storage device is for selecting a plurality of target objects in the video data corresponding to the specific view angle range, and generating a synthesized video data by combining each partial video data in the video data that corresponds to each of the target objects; wherein a view angle range of each partial video data is smaller than the specific view angle range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a generalized diagram illustrating a video processing system according to an embodiment of the present invention.

FIG. 2 is a block diagram illustrating a video processing system according to an embodiment of the present invention.

FIG. 3 is a diagram illustrating a video data, a full scene processed preliminary corrected video data, and a synthesized video data as shown in FIG. 2.

FIG. 4 is a flowchart illustrating a video processing method according to another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

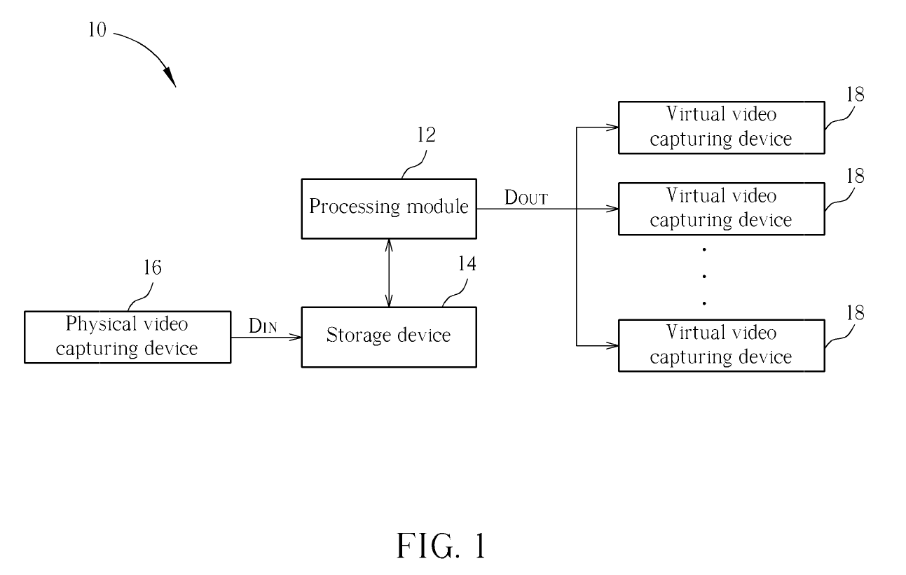

Please refer to FIG. 1. FIG. 1 is a generalized diagram illustrating a video processing system 10 according to an embodiment of the present invention. The video processing system 10 comprises a processing module 12, a storage device 14, a physical video capturing device 16, and at least one virtual video capturing device 18. Please note that the number of the virtual video capturing devices 18 in this embodiment is just an example for description purposes, and is not meant to be a limitation of the present invention. In other words, the virtual video capturing device 18 can be appropriately set up according to the requirements of the manufacturer. Furthermore, the virtual video capturing device 18 can be implemented in any practical way, such as an independent application program or an independent mechanism that relates to the operating system, and the present invention does not limit the ways of implementing the virtual video capturing device 18. The physical video capturing device 18 captures a scene corresponding to a specific view angle to generate a video data D_{IN}, and stores the video data D_{IN} into the storage device 14. Then, the processing module 12 selects a plurality of target objects from the video data D_{IN} corresponding to the specific view angle range stored in the storage device 14, and generates a synthesized video data D_{OUT} according to each of the partial video data in the video data D_{IN} that corresponds to each of the target objects, respectively; wherein a view angle range of each partial video data is smaller than the specific view angle range of the video data D_{IN}. Then, the processing module 12 transmits the synthesized video data D_{OUT} to the virtual video capturing device 18 for outputting to a device or apparatus that requires the synthesized video data D_{OUT}. Please note that the processing module 12 can be implemented by hardware, software, or a combination of hardware and software. In other words, any configuration that can achieve the function of the processing module 12 belongs to the scope of the present invention. In order to describe the technical characteristic of the present invention, the processing module 12 in the following description is implemented by a processor executed video controlling program. Please note that the disclosed embodiments in the following paragraph are just examples, and are not meant to be limitations of the present invention.

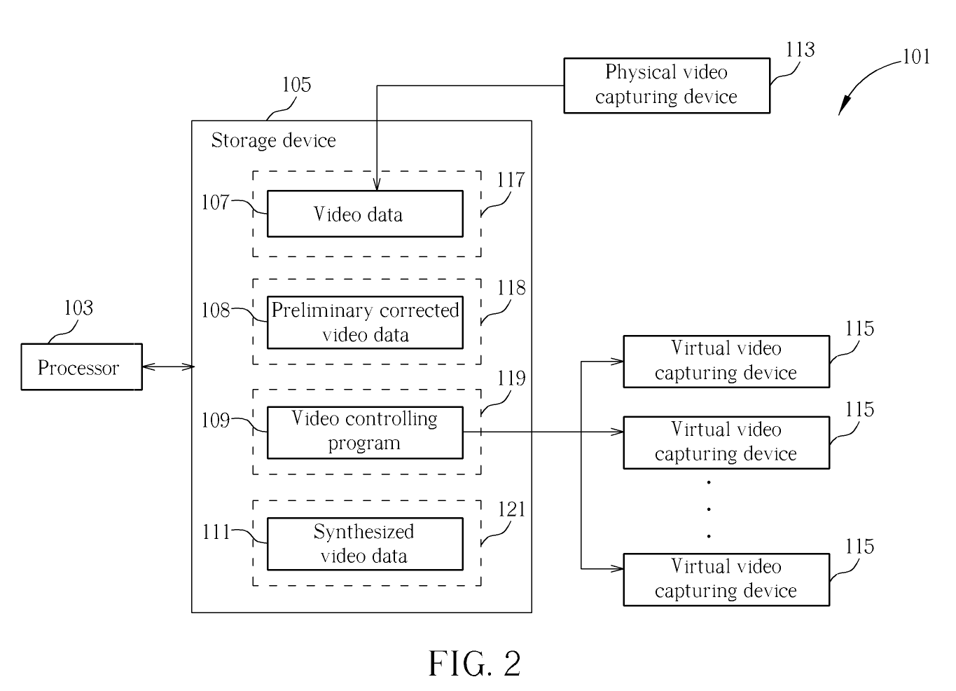

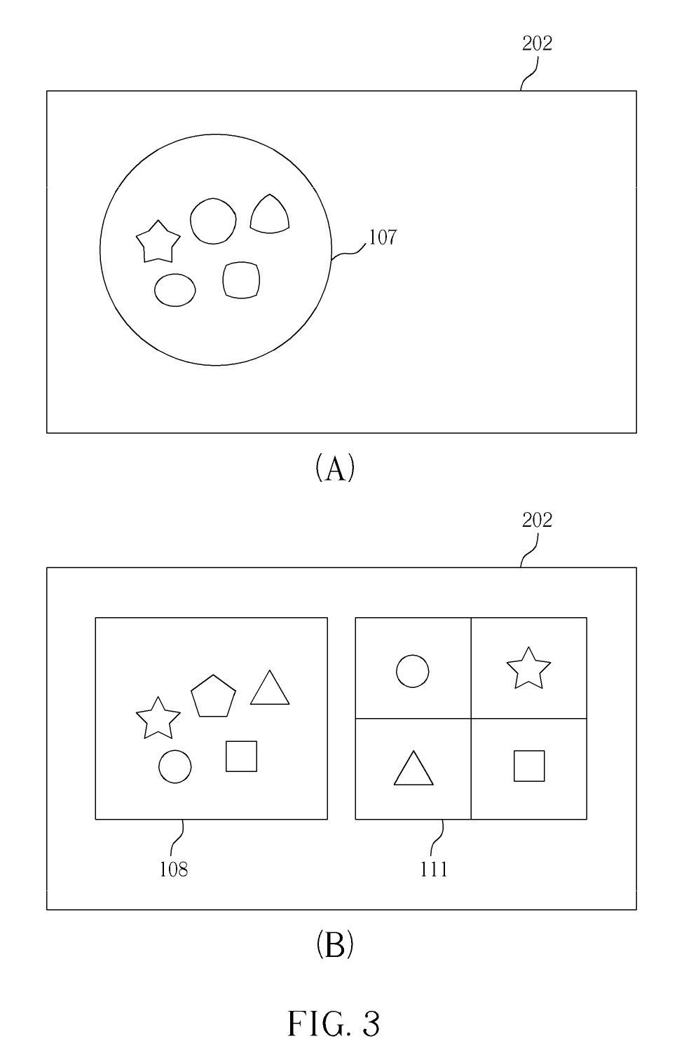

Please refer to FIG. 2 in conjunction with FIG. 3. FIG. 2 is a block diagram illustrating a video processing system 101 according to an embodiment of the present invention, and FIG. 3 is a diagram illustrating a video data 107, a full scene processed preliminary corrected video data 108, and a synthesized video data 111. According to the embodiment, the video processing system 101 comprises a processor 103, a storage device 105, a physical video capturing device 113, and at least one virtual video capturing device 115. Please note that the number of the virtual video capturing devices 115 in this embodiment is an example, and is not meant to be a limitation of the present invention. In other words, the virtual video capturing device 115 can be appropriately set up according to the requirements of the manufacturer. The processor 103 is utilized for executing a video controlling program 109 to implement the processing module 12 as shown in FIG. 1. Furthermore, the storage device 105 couples to the processor 103 as shown in FIG. 2, and the storage device 105 includes at least one first storage unit 117, a second storage unit 118, a third storage unit 119, and a fourth storage unit 121 for storing the video data 107 captured by the physical video capturing device 113, the full scene processed preliminary corrected video data 108, the video controlling program 109, and the synthesized video data 111, respectively. The first storage unit 117, the second storage unit 118, the third storage unit 119, and the fourth storage unit 121 can be implemented by a volatile storage unit (e.g., dynamic random access memory), nonvolatile storage unit (e.g., flash memory or hard disk), or a combination of a volatile storage unit and nonvolatile storage unit. Furthermore, the first storage unit 117, the second storage unit 118, the third storage unit 119, and the fourth storage unit 121 can be integrated into a storage device, or independently installed in different storage devices. In other words, according to the embodiment of the present invention, the storage device 105 is generally referred to the storage area that stores the video data 107, the full scene processed preliminary corrected video data 108, the video controlling program 109, and the synthesized video data 111.

According to the embodiment, the synthesized video data 111 (e.g., FIG. 3(B) in the FIG. 3) is displayed in a user interface (UI) 202, and the user interface (UI) 202 includes four sub-pictures to display each of the four partial video data corresponding to the four selected target objects, respectively. Please refer to FIG. 3. Each of the view angle ranges of the partial video data corresponding to each target object is smaller than the original view angle range corresponding to the video data 107 (e.g., FIG. 3(A) in FIG. 3). More specifically, the view angle of the view angle range corresponding to each partial video data in a diagonal direction is smaller than the view angle of the specific view angle range of the scene that is covered by the video data 107 in the diagonal direction. Please note that the selected target objects are not limited to the above-mentioned four target objects as shown in FIG. 3, and any other parts of the preliminary corrected video data 108 can be selected as the target objects according to the requirements or conditions of the user. According to the disclosed technique of the present invention, FIG. 3 only shows the objects in the video data 107 before the full screen processing, the objects in the preliminary corrected video data 108 after the full screen processing, and the target objects in the synthesized video data 111. In other words, the shapes and the sizes of the objects in the FIG. 3 are only used for description and not meant to be limitations of the present invention. Furthermore, the processor 103 further processes the video controlling program 109 to transfer the preliminary corrected video data 108 to the synthesized video data 111, and sets the synthesized video data 111 to be the output of the virtual video capturing device 115, wherein the preliminary corrected video data 108 is the video data 107 after performing a full screen processing. The detailed description is described in the following paragraph.

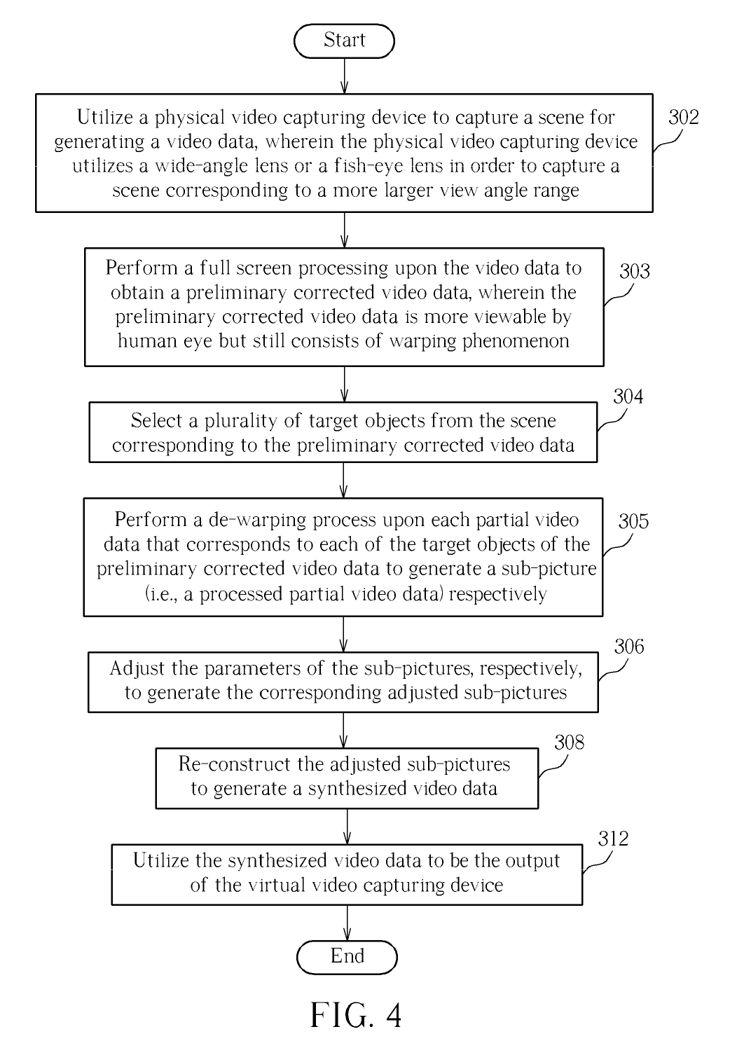

Please refer to FIG. 4. FIG. 4 is a flowchart illustrating a video processing method according to an embodiment of the present invention. Please note that, provided that substantially the same result is achieved, the steps of the flowchart shown in FIG. 4 need not be in the exact order shown and need not be contiguous, that is, other steps can be intermediate. The video processing method comprises the following steps:

Step 302: utilize a physical video capturing device to capture a scene for generating a video data, wherein the physical video capturing device utilizes a wide-angle lens or a fish-eye lens in order to capture a scene corresponding to a more larger view angle range;

Step 303: perform a full screen processing upon the video data to obtain a preliminary corrected video data, wherein the preliminary corrected video data is more viewable by human eye but still consists of warping phenomenon;

Step 304: select a plurality of target objects from the scene corresponding to the preliminary corrected video data;

Step 305: perform a de-warping process upon each partial video data that corresponds to each of the target objects of the preliminary corrected video data to generate a sub-picture (i.e., a processed partial video data) respectively;

Step 306: adjust the parameters of the sub-pictures, respectively, to generate the corresponding adjusted sub-pictures;

Step 308: re-construct the adjusted sub-pictures to generate a synthesized video data; and

Step 312: utilize the synthesized video data to be the output of the virtual video capturing device.

The following description provides details of the video processing system 101 executing the method in FIG. 4. Firstly, the physical video capturing unit 113 films the scene to generate video data 107 (Step 302), wherein the video data 107 is then stored in the first storage unit 117. According to the embodiment, the lens of the physical video capturing unit 113 is a wide-angle lens or a fish-eye lens (e.g., FIG. 3(A) of FIG. 3 is video data filmed by the fish-eye lens). This is just one example.

Since a focal length of the wide-angle lens is shorter than the focal length of a standard lens, where the view angle is larger than that of the human eye, and the focal length of the fish-eye lens is very short and its view angle is approximately to 180 or equal to 180⁰, when a wide-angle lens or a fish-eye lens is utilized as the lens of the physical video capturing device 113, a geometric warping phenomenon occurs upon the video data 107 (i.e., the video data 107 is a geometric warping video). Then, the video controlling program 109 that is executed by the processor 103 performs a full screen processing upon the video data 107 to obtain a preliminary corrected video data 108 (Step 303), wherein the preliminary corrected video data 108 is more viewable by the human eye but still consists of warping phenomenon. Furthermore, the processor 103 automatically loads a reversed warping parameter or manually adjusts the view angle range corresponding to the classification of lens, and then performs a de-warping process upon the partial video data in the preliminary corrected video data 108 corresponding to each selected target object in the preliminary corrected video data 108 (Step 305). Since the de-warping process is well-known, details are omitted here for brevity. The video controlling program 109 also adjusts the direction of the lens with respect to different locations of the lens. Furthermore, any adjusting methods related to the video processing can be utilized as the video controlling program 109, and this also belongs to the scope of the present invention.

In addition, according to the embodiment, the processor 103 executes the video controlling program 109 for the user to select a plurality of target objects from the scene corresponding to the preliminary corrected video data 108 via the user interface 202 (Step 304). Then, the video controlling program 109 executed by the processor 103 generates a sub-picture (i.e., processed partial video data) corresponding to each of the partial video data in the preliminary corrected video data 108 according to each of the target objects, respectively, and displays the sub-pictures on the right-half part of the user interface 202 as shown in FIG. 3(B) of FIG. 3. According to the embodiment, the number of the target objects is four, and therefore the number of the generated sub-pictures is also four. Furthermore, the method of selecting the target objects is not limited to manual setting, but also comprises automatic setting of the target objects in the target object selecting operation. For example, the target object selecting operation automatic selects the target object when a triggering condition is met, such as performing a motion detection upon the preliminary corrected video data 108 to determine if the triggering condition is met, and automatically selects the target object from the scene corresponding to the preliminary corrected video data 108 (e.g., when a moving object occurs in the scene corresponding to the preliminary corrected video data 108, the scene satisfies the triggering condition and the moving object is automatically selected to be the target object), or performing a face detection upon the preliminary corrected video data 108 to determine if the triggering condition is met, and automatically selecting the target object from the scene corresponding to the preliminary corrected video data 108 (e.g., when a human face occurs in the scene corresponding to the preliminary corrected video data 108, the scene meets the triggering condition and then the human face is automatically selected to be the target object). Please note that the above-mentioned examples are not meant to be limiting conditions of the present invention, and any other part of the preliminary corrected video data 108 can also be selected as the target object through user defined or other specific conditions.

Then, the present invention adjusts the parameters of the sub-pictures to generate the adjusted sub-pictures, and displays the adjusted sub-pictures on the right-half part of the user interface 202 (Step 306). The video controlling program 109 executed by the processor 103 provides the user interface 202 for the user to manually adjust the parameters of each of the sub-pictures, in which the parameters include classification of lens, direction of lens, projection form, technique of interpolation, etc. For instance, the video controlling program 109 executed by the processor 103 further adjusts the view angle range of the partial video data corresponding to each of the sub-pictures to generate an adjusted partial video data. Please note that the operation to further adjust (e.g. fine tune the view angle range) the partial video data corresponding to each of the sub-pictures is not limited to manual adjusting, and can also be accomplished automatically by the system.

Finally, the video controlling program 109 re-constructs the plurality of processed sub-pictures (i.e., processed partial video data) to generate a new picture that corresponds to the synthesized video data 111 as shown in FIG. 3(B) of FIG. 3, and then stores the new picture into the fourth storage unit 121, wherein the synthesized video data 111 is displayed on the right-half part of the user interface 202. Furthermore, the video controlling program 109 executed by the processor 103 further sets the synthesized video data 111 as the output of the virtual video capturing device 115. According to an embodiment of the present invention, if the selected target object is a person in a scene (e.g., an attendant of a video conference), then the virtual video capturing device 115 can be utilized for providing a real time communication software (e.g., MSN or Skype) to call the person. Therefore, the virtual video capturing device 115 reads the synthesized video data 111 to perform the video displaying.

Please note that, in this embodiment, although the video controlling program 119 selects four target objects to generate the synthesized video data 111, the video controlling program 119 is capable of selecting more or fewer target objects to generate the synthesized video data 111 according to the above-mentioned theory or practical conditions in another embodiment.

In other words, after the video processing method and the related system obtains the video data 107 that is captured by the physical video capturing device 113, the video data 107 is processed appropriately (such as full screen process, de-warping process, sub-picture parameters adjusting, etc.) to generate the required synthesized video data 111, where the order or the method of the video processing can be dynamically adjusted according to practical requirements.

Furthermore, according to the flowchart of FIG. 4, the step of performing the full screen processing is optional (Step 303), therefore the step 303 in FIG. 4 can be selectively omitted according to the practical or user requirements. The method omitting step 303 also captures the plurality of partial video data corresponding to smaller view angle ranges from the video data that correspond to the larger view angle range to generate a synthesized video. Thus, the above-mentioned design also belongs to the scope of the present invention.

The present invention provides a video processing method and video processing system to capture a plurality of partial video data from the video data to generate a synthesized video data, wherein the video data has a larger view angle range and the plurality of partial video data have smaller view angle ranges. Accordingly, the present invention can determine required target objects in the video data to construct a specific new video in a more efficient and precise way. More specifically, according to the embodiment of the present invention, the video data that is desired by the user can be selected, to therefore reduce the system resources and the cost. For instance, according to the above-mentioned embodiment of the present invention, only one physical video capturing device is utilized in the video conference, but this is sufficient to obtain the images of a plurality of attendants of the conference after processing the video data corresponding to the same video. The facial expression of each of the attendants of the conference can be clearly observed and subsequently a more effective meeting can be carried out.

Please note that the technique and theory disclosed in the embodiment of the present invention can be applied in different video processing modules, which can include video capturing devices (e.g., web cameras), video displaying devices (e.g., monitors), or other devices. Furthermore, those skilled in this art are capable of applying the present invention in other similar fields after reading the disclosed operation and method of the present invention. In addition, those skilled in the field of electronic circuit design, signal processing, or video processing are also capable of implementing the virtual video capturing device of the video processing system of the present invention through the technique of electronic circuit design or software programming editing after reading the disclosed operation and method of the present invention.

Those skilled in the art will readily observe that numerous modifications and alterations of the device and method may be made while retaining the teachings of the invention.

What is claimed is:

1. A video processing method, comprises:
storing a video data corresponding to a specific view angle range;
selecting a plurality of target objects in the video data corresponding to the specific view angle range; and
generating a synthesized video data by combining each partial video data in the video data that corresponds to each of the target objects;
wherein a view angle range of each partial video data is smaller than the specific view angle range.

2. The video processing method of claim 1, further comprising:
capturing a scene corresponding to the specific view angle to generate the video data via a material video capturing device, wherein a lens of the material video capturing device is a wide-angle lens or a fish-eye lens.

3. The video processing method of claim 2, wherein the video data corresponds to a geometric warping video caused by the lens of the material video capturing device, and the step of generating the synthesized video data comprises:
performing a de-warping process upon each partial video data that corresponds to each of the target objects to generate a processed partial video data; and
combining the processed partial video data corresponding to each of the target objects to generate the synthesized video.

4. The video processing method of claim 3, wherein the step of selecting the target objects in the video data corresponding to the specific view angle range comprises:
performing a full scene processing upon the video data to obtain a preliminary corrected video data; and
selecting the target objects in the preliminary corrected video data corresponding to the specific view angle range.

5. The video processing method of claim 1, wherein the step of generating the synthesized video data comprises:
performing a view angle range adjustment to adjust a view angle range corresponding to a partial video data of at least one target object; and
combining the partial video data of each of the target objects to generate the synthesized video data.

6. The video processing method of claim 5, wherein setting of the view angle range in the step of performing the view angle range adjustment is automatically assigned by a system or manually assigned by a user.

7. The video processing method of claim 1, wherein the step of selecting the target objects comprises:
performing a target object selecting operation to select the target objects in the video data corresponding to the specific view angle range, wherein target object selection setting of the target object selecting operation is automatically assigned by a system or manually assigned by a user.

8. The video processing method of claim 7, wherein the target object selection setting of the target object selecting operation is automatically assigned by the system, and the target object selecting operation automatically selects the target object when a triggering condition is met.

9. The video processing method of claim 8, wherein the target object selecting operation performs a motion detection to determine if the triggering condition is met, and the triggering condition is met when a moving object appears in the specific view angle range, and the target object selecting operation automatically determines the moving object to be the target object.

10. The video processing method of claim 8, wherein the target object selecting operation performs a face detection to determine if the triggering condition is met, and the triggering condition is met when a moving object consisting of facial contours appears in the specific view angle range, and the target object selecting operation automatically determines the moving object consisting of facial contours to be the target object.

11. The video processing method of claim 1, wherein a view angle of a diagonal direction of the view angle range corresponding to each partial video data is smaller than the view angle of the diagonal direction of the specific view angle range.

12. A video processing system, comprising:
a storage device, for storing a video data corresponding to a specific view angle range; and
a processing module, coupled to the storage device, for selecting a plurality of target objects in the video data corresponding to the specific view angle range, and generating a synthesized video data by combining each partial video data in the video data that corresponds to each of the target objects;
wherein a view angle range of each partial video data is smaller than the specific view angle range.

13. The video processing system of claim 12, further comprising:
a material video capturing device, for capturing a scene corresponding to the specific view angle to generate the video data, wherein a lens of the material video capturing device is a wide-angle lens or a fish-eye lens.

14. The video processing system of claim 13, wherein the video data corresponds to a geometric warping video caused by the lens of the material video capturing device, and the processing module performs a de-warping process upon each partial video data that corresponds to each of the target objects to generate a processed partial video data, and combines the processed partial video data corresponding to each of the target objects to generate the synthesized video.

15. The video processing system of claim 12, wherein the processing module further performs a full scene processing upon the video data to obtain a preliminary corrected video data, and the processing module selects the target objects in the preliminary corrected video data corresponding to the specific view angle range.

16. The video processing system of claim 12, wherein the processing module further performs a view angle range adjusting to adjust a view angle range corresponding to a partial video data of at least one target object, and then combines the partial video data of each of the target objects to generate the synthesized video data.

17. The video processing system of claim 16, wherein setting of the view angle range in the view angle range adjusting is automatically assigned by a system or manually assigned by a user.

18. The video processing method of claim 12, wherein the processing module performs a target object selecting operation to select the target objects in the video data corresponding to the specific view angle range, wherein target object selection setting of the target object selecting operation is automatically assigned by a system or manually assigned by a user.

19. The video processing system of claim 18, wherein the target object selection setting of the target object selecting operation is automatically assigned by the system, and the target object selecting operation automatically selects the target object when a triggering condition is met.

20. The video processing system of claim 19, wherein the target object selecting operation performs a motion detection to determine if the triggering condition is met, and the triggering condition is met when a moving object appears in the specific view angle range, and the target object selecting operation automatically determines the moving object to be the target object.

21. The video processing system of claim 19, wherein the target object selecting operation performs a face detection to determine if the triggering condition is met, and the triggering condition is met when a moving object consisting of facial contours appears in the specific view angle range, and the target object selecting operation automatically determines the moving object consisting of facial contours to be the target object.

22. The video processing system of claim 12, wherein a view angle of a diagonal direction of the view angle range corresponding to each partial video data is smaller than the view angle of the diagonal direction of the specific view angle range.
